(19) United States
(12) Patent Application Publication
(10) Pub. No.: US 2009/0226094 A1
(43) Pub. Date: Sep. 10, 2009

(54) IMAGE CORRECTING DEVICE AND METHOD, AND COMPUTER PROGRAM

(75) Inventor: Osamu Yamazaki, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 12/440,789

(22) PCT Filed: Sep. 13, 2006
(86) PCT No.: PCT/JP2006/318168

§ 371 Date: Apr. 9, 2009

(51) Int. Cl. G06K 9/46; G06K 9/40

(52) U.S. Cl. 382/190; 382/254

(57) ABSTRACT

An image correcting device (1) is include of a feature point detecting element (3, 4 and 5) for detecting sets of feature points (Q_{A0}, Q_{A1}, . . . ) from a plurality of images (2) picked up at a plurality of places (a, b) by a pickup element, a change detecting element (7) for detecting relative changes among images with respect to the detected sets of the feature points, and a first specifying element (8) for specifying rotation quantities of the image pickup element among the places in accordance with the detected changes. The feature point detecting element detects set of points belonging to a plane-like stationary object (310) as sets of feature points.

### TECHNICAL FIELD

The present invention relates to an image correcting apparatus for and method of specifying the displacement parameter (e.g. the amount of rotation and the amount of parallel displacement) of an imaging element and using it for the correction of taken images or the like, and a computer program which makes a computer function as such an image correcting apparatus.

### BACKGROUND ART

In this type of image correcting apparatus, several feature points are selected from the taken images in specifying the displacement parameter which indicates how the imaging element is displaced between imaging points, and the displacement of the feature points is focused on to specify the displacement parameter. If noise is selected as the feature point, it is hardly possible to ignore an influence of errors. Thus, there is a possibility that the displacement parameter cannot be accurately obtained.

Thus, there is known a technology of searching for the displacement of the feature point between the images, evaluating the errors, and statistically detecting the displacement parameter (refer to a non-patent document 1).

There is also suggested a technology of using the displacement of the vanishing point of horizontal lines which are parallel to each other and of the vanishing point of perpendicular line segments which are parallel to each other, in order to separately obtain the amount of rotation and the amount of parallel displacement, of the displacement parameter (refer to a non-patent document 2).

Moreover, there is also suggested a technology of detecting the vanishing point by using a white line on a road (refer to a patent document 1).

Non-patent document 1: IEEE TRANS. ON SYSTEM, MAN AND CYBERNETICS, VOL. 19, NO. 6, NOV./DEC. 1989 pp. 1426-1446 Non-patent document 2: Journal of Institute of Electronics and Communication Engineers of Japan, '86/6 VOL. J-69-D NO. 6 pp. 967-974

Patent document 1: Japanese Patent Application Laid Open No. Hei7-78240

### DISCLOSURE OF INVENTION

### Subject to be Solved by the Invention

However, in the technology disclosed in the aforementioned non-patent document 1, a problem likely occurs in terms of the calculation amount. For example, if an optical flow of many feature points is obtained, statistic calculation is necessary, and a huge amount of calculation is likely required.

In the technology disclosed in the aforementioned non-patent document 2, the couple of straight lines needs to be parallel in the real world. Therefore, the errors could be caused by selecting the straight lines which are not parallel, as candidates, like a circular advertising sign.

In the technology disclosed in the aforementioned patent document 1, the errors could be caused when the while line is not the straight line because it cannot be adjusted.

In view of the aforementioned problems, it is therefore an object of the present invention to provide an image correcting apparatus and method in which it is possible to preferably reduce the calculation amount required for the specification of the aforementioned displacement parameter, and a computer program which makes a computer function as such an image correcting apparatus.

### Means for Solving the Subject

(Image Correcting Apparatus)

The above object of the present invention can be achieved by an image correcting apparatus provided with: a feature point detecting device for detecting a set of feature points from a plurality of images taken at a plurality of points by an imaging element; a change detecting device for detecting a change in relative positions between the images, with respect to the detected set of feature points; and a first specifying device for specifying amount of rotation between the points of the imaging element, on the basis of the detected change, the feature point detecting device detecting a set of points which belongs to a plane-like stationary object, as the set of the feature points.

According to the image correcting apparatus of the present invention, firstly, from the plurality of images taken by the imaging element such as a camera at the plurality of points, the set of the feature points is detected by the feature point detecting device having a memory, an arithmetic element, and the like. The term “plurality” herein denotes that it is greater than or equal to two, and it is typically two. The imaging element is displaced between the points, and it takes the plurality of images. The “image” is a map on the two-dimensional plane of an object. The “displacement” includes rotation displacement and parallel displacement, and the “displacement parameter” includes the amount of rotation and the amount of parallel displacement. The “feature point” is a point or a small area in the image, which can be easily detected in image processing.

Then, the change in the relative positions between the images is detected with respect to the detected set of the feature points, by the change detecting device having a memory, an arithmetic element, and the like. The “change” herein is a change in the relative positions between the images of each feature point, and in other words, a change in the mutual position relation. It is such a concept that if the imaging point or the direction of the imaging element varies, although it is the same object (which is the feature point in this case), the position on the taken image varies.

Then, on the basis of the detected change, the amount of rotation between the points of the imaging element is specified by the first specifying device having a memory, an arithmetic element, and the like.

Here, in general, if the feature point detecting device randomly detects the set of the feature points, for example, a statistical method is used to specify the amount of rotation. Thus, the calculation amount is likely huge.

However, the feature point detecting device in the present invention uses a recognition method such as template matching, to thereby detect the set of the points which belongs to the plane-like stationary object, such as an advertising sign and a street directory, as the set of the feature points. The term “plane-like” indicates having a flat surface, However, being flat is not necessarily required in a strict sense. For example, like an advertising sign, it is such a concept that allows a case where the curvature of the entire surface is smaller than a predetermined curvature threshold value even if the surface has an uneven pattern or a concavo-convex pattern. The term “stationary” includes a low speed enough to be ignored, compared to the moving speed of the imaging element, and it does not necessarily require being absolutely still. How “plane-like” and how “stationary” may be set in accordance with the required accuracy, by experiments or simulation in advance. Then, on the premise that each feature point is the point which belongs to the plane-like stationary object, the calculation is performed to specify the amount of rotation. Therefore, it is possible to preferably reduce the calculation amount required for the specification of the amount of rotation, which is one example of the displacement parameter. As described above, if the amount of rotation is preferably specified, the correction can be made with the specified amount of rotation when the distance to the feature point is measured by analyzing the image taken at each point, so that it is extremely useful in practice.

In one aspect of the image correcting apparatus of the present invention, the first specifying device specifies the amount of rotation, as amount of rotation that the relative positions of the feature points are similar to each other between the images.

According to this aspect, the amount of rotation that the relative positions of the feature points are similar to each other between the images is specified by the first specifying device. The “relative positions of the feature points” herein are the relative position relation of the feature points based on a certain feature point, and in other words, the graphic shapes formed by the set of the feature points. In general, the planes (i.e. the plane-like stationary object and an imaging area) can be made parallel to each other only by rotation. If the planes are parallel, the set of the feature points which belongs to one of the planes is mapped to be a similar shape on the other plane. As opposed to this, the imaging area of the imaging element can be rotated such that the set of the feature points which belongs to the plane-like stationary object is similar to the map on the certain imaging area, and the amount of rotation at that time may be set to the aforementioned amount of rotation.

In another aspect of the image correcting apparatus of the present invention, the first specifying device determines one feature point of the detected set of the feature points as a reference point, calculates a relative vector directed from the determined reference point to each of other feature points, and specifies the amount of rotation such that the calculated relative vectors are similar between the images.

In the aspect focusing on the similarity, the first specifying device may determine one feature point of the detected set of the feature points as the reference point, calculate the relative vector directed from the determined reference point to each of other feature points, and specify the amount of rotation such that the calculated relative vectors are similar between the images.

According to this aspect, the aforementioned relative positions of the feature points are expressed by the relative vectors. Thus, the first specifying device can specifically specify the amount of rotation, with the rotation displacement being as a “rotation matrix” and with the parallel displacement being as the addition of the vectors.

In this aspect, the feature point detecting device may detect a set of points which constitutes a known shape, as the set of the feature points.

According to this aspect, the set of the points which constitutes the known shape is detected as the set of the feature points by the feature point detecting device. The “known shape” herein is a shape whose equations for expressing the shape or whose graphical features are known, such as a straight line, a circle, or a rectangle. For example, if the set of the feature points makes a rectangle, the amount of rotation is specified such that the set of the feature points of the taken images makes a rectangle. At this time, by using the condition that the opposite sides are parallel to each other, the calculation can be performed, more accurately and efficiently.

In another aspect of the image correcting apparatus of the present invention, it is further provided with: a measuring device for measuring a distance between the points of the imaging element; and a second specifying device for specifying amount of parallel displacement between the points of the imaging element, on the basis of the specified amount of rotation and the measured distance between the points of the imaging element.

According to this aspect, the distance between the points in which the imaging element is displaced is measured by the measuring device having, for example, a displacement sensor. On the basis of the measured distance between the points and the amount of rotation specified in the aforementioned manner, the second specifying device can specify the amount of parallel displacement between the points of the imaging element. Specifically, by rotating the three-dimensional coordinate axes of the imaging element at the both points on the basis of the specified amount of rotation, the axes at the both points are made parallel to each other. As a result, the both coordinate axes can be matched to each other by the parallel displacement, and the amount of parallel displacement at this time can be specified as the desired amount of parallel displacement.

In another aspect of the image correcting apparatus of the present invention, the change detecting device detect the change about an arbitrary feature point, in addition to the set of the feature points, and the image correcting apparatus further provided with a calculating device for calculating a distance to the arbitrary feature point, at least on the basis of the detected change about the arbitrary feature point.

According to this aspect, the change about the arbitrary feature point is detected by the change detecting device, in addition to the set of the feature points. The term arbitrary” herein is a concept including the feature point which does not belong to the plane-like stationary object. Then, the distance to the arbitrary feature point is calculated by the calculating device, at least on the basis of the detected change about the arbitrary feature point. In other words, by applying the result of the amount of rotation or the like, it is possible to calculate the distance to the arbitrary feature point, so that it is extremely useful in practice.

In another aspect of the image correcting apparatus of the present invention, it is further provided with: a reducing device for reducing an area of the images which is a target to detect the change, on the basis of at least one of the change about the plane-like stationary object and the distance between the points of the imaging element.

According to this aspect, for example, the change about the plane-like stationary object is derived by pattern matching, or the distance between the points is derived by hardware such as a displacement sensor. On the basis of at least one of them, the area which is a target to detect the change of the images is reduced by the reducing device having a memory, an arithmetic element, and the like. For example, the area is reduced such that the plane-like stationary object occupies the area. As a result, it is possible to limit only the vicinity of the stationary object to be in an optical flow search area, so that the calculation amount is expected to be reduced, which is extremely useful in practice.

In another aspect of the image correcting apparatus of the present invention, it is further provided with: a recording device for recording at least one candidate of the feature points and the plane-like stationary object, the feature point detecting device detecting the feature points with reference to the recorded candidate.

According to this aspect, at least one candidate of the feature points and the plane-like stationary object is recorded as a so-called template by the recording device having a hard disk or the like. Then, referring to the recorded candidate allows the accuracy of detecting the feature points and the plane-like stationary object to be improved, resulting in the accurate detection of the feature points.

(Image Correcting Method)

The above object of the present invention can be also achieved by an image correcting method provided with: a feature point detecting process of detecting a set of feature points from a plurality of images taken at a plurality of points by an imaging element; a change detecting process of detecting a change in relative positions between the images, with respect to the detected set of feature points; and a first specifying process of specifying amount of rotation between the points of the imaging element, on the basis of the detected change, the feature point detecting process detecting a set of points which belongs to a plane-like stationary object, as the set of the feature points.

Incidentally, even in the image correcting method of the present invention, it is possible to receive the save various aspects as those of the image correcting apparatus of the present invention.

(Computer Program)

The above object of the present invention can be also achieved by a computer program making a computer function as the image correcting apparatus of the present invention.

According to the computer program of the present invention, the image correcting apparatus of the present invention described above can be relatively easily realized as a computer reads and executes the computer program from a program storage device, such as a ROM, a CD-ROM, a DVD-ROM, and a hard disk, or as it executes the computer program after downloading the program through a communication device.

Incidentally, even in the computer program of the present invention, it is possible to receive the save various aspects as those of the image correcting apparatus of the present invention.

As explained above, according to the image correcting apparatus of the present invention, it is provided with the feature point detecting device, the change detecting device, and the first specifying device. According to the image correcting method of the present invention, it is provided with the feature point detecting process, the change detecting process, and the first specifying process. Thus, it is possible to preferably reduce the calculation amount required for the specification of the displacement parameter. Moreover, according to the computer program of the present invention, it makes a computer function as the feature point detecting device, the change detecting device, and the first specifying device. Thus, it is possible to establish the aforementioned image correcting apparatus of the present invention, relatively easily.

The above object of the present invention can be also achieved by a computer program product in a computer-readable medium for tangibly embodying a program of instructions executable by a computer provided in the aforementioned image correcting apparatus of the present invention (including its various aspects), the computer program product making the computer function as at least one portion of the image correcting apparatus (specifically, for example, at least one of the feature point detecting device, the change detecting device, and the first specifying device).

According to the embodiment of the computer program product of the present invention, the image correcting apparatus of the present invention described above can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the image correcting apparatus of the present invention described above.

The operation and other advantages of the present invention will become more apparent from the embodiments explained below.

### BRIEF DESCRIPTION OF DRAWINGS

FIG. 1 is a perspective view showing a coordinate system in a first embodiment.

FIG. 2 is a perspective view showing that an imaging area is displaced in a moving stereo method.

FIG. 3 are conceptual views showing a relation between a map and a transformed map in the first embodiment.

FIG. 4 is a block diagram conceptually showing the basic structure of an image correcting apparatus in the first embodiment of the present invention.

FIG. 5 is a flowchart showing the operation process of the image correcting apparatus in the first embodiment of the present invention.

FIG. 6 is a flowchart showing the detailed operation process of the image correcting apparatus in the first embodiment of the present invention.

FIG. 7 is a perspective view showing a coordinate system in a second embodiment.

FIG. 8 is a flowchart showing the operation process of an image correcting apparatus in the second embodiment of the present invention.

FIG. 9 is a block diagram conceptually showing the basic structure of an image correcting apparatus in a third embodiment of the present invention.

FIG. 10 is a block diagram conceptually showing the basic structure of an image correcting apparatus in a fourth embodiment of the present invention.

FIG. 11 is a block diagram conceptually snowing the basic structure of an image correcting apparatus in a fifth embodiment of the present invention.

FIG. 12 is a block diagram conceptually showing the basic structure of an image correcting apparatus in a sixth embodiment of the present invention.

FIG. 13 is a block diagram conceptually showing the basic structure of an image correcting apparatus in a seventh embodiment of the present invention.

FIG. 14 is a block diagram conceptually showing the basic structure of an image correcting apparatus in an eighth embodiment of the present invention.

FIG. 15 is a block diagram conceptually showing the basic structure of an image correcting apparatus in a ninth embodiment of the present invention.

### DESCRIPTION OF REFERENCE CODES

1 image correcting apparatus
320 imaging area
300 plane
310 object
2 image
3 stationary object map detecting device
4 stationary object plane detecting device
5 feature point detecting device
6 feature point recording device
65 feature point displacement amount detecting device
7 feature point change detecting device
8 imaging element rotation amount detecting device

### BEST MODE FOR CARRYING OUT THE INVENTION

Hereinafter, the best mode for carrying out the invention will be explained in each embodiment in order, with reference to the drawings.

### (1) First Embodiment

The structure and operation process of an image correcting apparatus in a first embodiment will be described with reference to FIG. 1 to FIG. 6.

(1-1) As for Moving Stereoscopic Method and Displacement Parameter

Before the structure and operation process of the image correcting apparatus are explained, a moving stereoscopic method will be explained as an example of use of the displacement parameter. The moving stereoscopic method is one example of a technique for measuring a distance to an object. According to the moving stereoscopic method, an imaging element such as a camera is displaced to take images at a plurality of points, and the image taken at each point is used to measure the distance to the object on the basis of the principle of triangulation. In the measurement, it is necessary to obtain the displacement parameter which indicates how the camera is displaced between the imaging points, i.e. a rotational component and a parallel displacement component.

In order to give an explanation to the moving stereoscopic method, firstly, a three-dimensional coordinate system in which a pinhole is used as an origin O is considered using FIG. 1. FIG. 1 is a perspective view showing the coordinate system in the first embodiment.

In FIG. 1, it is assumed that the pinhole of a pinhole camera is the origin O, that the lateral direction and longitudinal direction of an imaging area 320 disposed at a focal distance are an X axis and a Y axis, respectively, and that an optical axis is a Z axis. If the two-dimensional coordinates of the imaging area 320 are (u, v), the point of three-dimensional coordinates (x, y, z) is mapped as in an Equation 1.

$$[ \begin{matrix}u \\ v\end{matrix} ] = f [ \begin{matrix}x / z \\ y / z\end{matrix} ] \qquad [ Equation 1 ]$$

A set of a plurality of points mapped constitutes an image. Taking the image at a plurality of points will be explained in FIG. 2. FIG. 2 is a perspective view showing that the image is taken at a plurality of points in a moving stereo method.

In FIG. 2, the imaging element having the imaging area 320 is displaced from a point a to a point b around a feature point Q, and it takes images of the feature point Q at both points. The displacement parameter of the imaging element is broken into a three-axis rotation matrix by a yaw angle φ, a pitch angle θ, and a roll angle φ, and three-axis parallel displacement elements Δx, Δy, and Δz. The transformation from a coordinate system (X, Y, Z) of the imaging area 320 at the point a to a coordinate system (X′, Y′, Z′) of the imaging area 320 at the point b is expressed in an Equation 2.

$$[ \begin{matrix}{X}^{′} \\ {Y}^{′} \\ {Z}^{′}\end{matrix} ] = R ( φ , θ , ϕ ) [ \begin{matrix}X \\ Y \\ Z\end{matrix} ] + [ \begin{matrix}Δ x \\ Δ y \\ Δ z\end{matrix} ] \qquad [ Equation 2 ]$$

Here, the Equation 2 is an equation with six unknowns of φ, θ, φ, Δx, Δy, and Δz. Therefore, if six feature points are simply selected in the image and if it is known how far the feature points are displaced on the (u, v) plane between the points a and b, the Equation 2 is to be solved using the Equation 1. However, if the six feature points are randomly selected in this method, noise is likely selected as the feature point, so it is hardly possible to ignore an influence of errors. In order to reduce the errors, a statistic process can be used to improve the accuracy; however, it has a huge calculation amount.

Thus, in the embodiment, it is devised how to select the feature points, and it is tried to reduce the calculation amount required to solve the Equation 2.

Specifically, in FIG. 1, it is assumed that an object 310 which belongs to a plane 300 such as an advertising sign is imaged and that the feature points are selected from among points included in the object 310 which belongs to the plane 300. If the feature points are selected in this manner, the following relatively simple calculation allows the specification of the displacement parameter of the Equation 2. In other words, the object 310 which belongs to the plane 300 and its map in the imaging area 320 are similar when the plane 300 and the imaging area 320 are parallel, and it is independent of the imaging positions. Thus, in case of the maps of the object 310 which belongs to the plane 300, the rotation matrix can be obtained such that the transformed maps are similar to each other in the respective images. By this, the rotation matrix of the Equation 2 can be obtained.

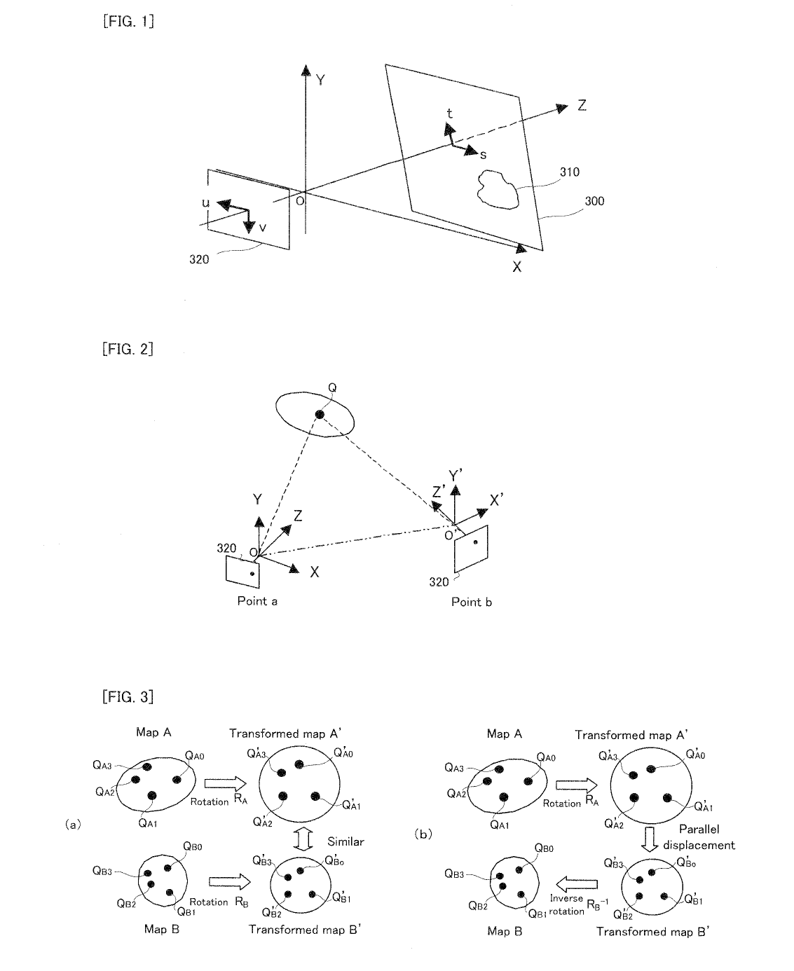

Focusing on the similarity to obtain the rotation matrix will be detailed in FIG. 3. FIG. 3 are conceptual views showing a relation between the map and the transformed map in the first embodiment.

In FIG. 3(a), it is assumed that the transformed maps obtained by transforming maps A and B in images A and B with a rotation matrix R_{A, B} are transformed maps A and B, respectively (in random order). At this time, the rotation matrix R_{A, B} is obtained by using the condition that the transformed maps A and B are similar to each other, as described above. Therefore, the feature points included in the object 310 are detected. If the maps of the object 310 are similar, the rotation matrix R_{A, B} is obtained such that the relative positions of the feature points (e.g. a quadrangle Q_{A0}Q_{A1}Q_{A2}Q_{A3} and a quadrangle Q_{B0}Q_{B1}Q_{B2}Q_{B3}) are all similar.

Moreover, this relation can be expressed as in FIG. 3(b); namely, the transformed map A obtained by transforming the map A by a rotation matrix R_{A} is parallel-displaced, to thereby provide the transformed map B. This is because the transformed maps A and B are similar. The transformed map B is inversely rotated by an inverse matrix R_{B}⁻¹ of a rotation matrix R_{B}, to thereby provide the map B. Therefore, the Equation 2 is changed to an Equation 3.

$$[ \begin{matrix}{X}^{′} \\ {Y}^{′} \\ {Z}^{′}\end{matrix} ] = {R}_{B}^{- 1} \{ {R}_{A} [ \begin{matrix}X \\ Y \\ Z\end{matrix} ] + [ \begin{matrix}Δ {x}^{′} \\ Δ {y}^{′} \\ Δ {z}^{′}\end{matrix} ] \} \qquad [ Equation 3 ]$$

In other words, it can be said that the Equation 3 may be solved instead of the Equation 2. As a result, if the rotation matrices R_{A} and R_{B} are obtained, a rotation matrix R can be obtained. At this time, it can be said that R_{A} and R_{B} are the rotation matrices that make the imaging area 320 and the plane 300 parallel to each other at the points a and b at which the images A and B are taken, respectively.

As explained above, by limiting how to select the feature points to be within the plane 300, it is possible to mainly receive the following three merits.

Firstly, with the plane 300 as a reference plane, a relative angle (e.g. the rotation matrices R_{A} and R_{B}) which allows the plane 300 and the imaging area 320 at each imaging point to be parallel is obtained, relatively easily. This simplifies the calculation of a rotation angle (e.g. the rotation matrix R).

Secondly, if the rotation transformation is performed, for example, by the rotation matrices R_{A} and R_{B} such that the imaging area 320 at each imaging point is parallel to the plane 300, the displacement of the feature points after the transformation is influenced only by the parallel displacement. This simplifies the calculation of the amount of parallel displacement (e.g. Δx, Δy, and Δz).

Thirdly, if the rotation transformation is performed as described above, all the feature points which belong to the plane 300 are equally distant on the optical axis from the imaging area 320. At this time, the amount of parallel displacement coincides in each feature point, so that it is possible to predict the displacement of each feature point. As a result, it is possible to remove what makes an abnormal move from the feature point candidates, which makes it resistant to the errors.

In order to receive the aforementioned merits, the image correcting apparatus in the embodiment is constructed as follows.

(1-2) Basic Structure

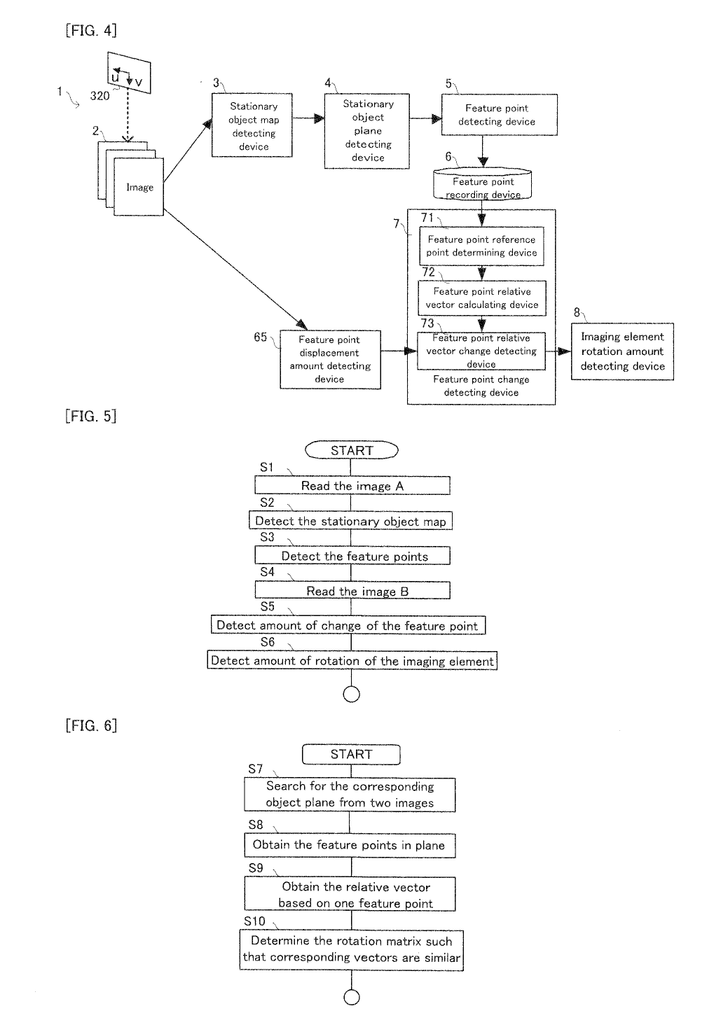

Next, the basic structure of the image correcting apparatus in the embodiment will be explained with reference to FIG. 4, in addition to FIG. 1 to FIG. 3. FIG. 4 is a block diagram conceptually showing the basic structure of the image correcting apparatus in the first embodiment of the present invention.

As shown in FIG. 4, an image correcting apparatus 1 in the embodiment is provided with a stationary object map detecting device 3, a stationary object plane detecting device 4, a feature point detecting device 5, and a feature recording device 6, which are one example of the “feature point detecting device” of the present invention; a feature point displacement amount detecting device 65; a feature point change detecting device 7, which is one example of the “change detecting device” of the present invention; and an imaging element rotation amount detecting device 8, which is one example of the “first specifying device” of the present invention. The image correcting apparatus 1 is adapted to preferably reduce the calculation amount required for the specification of the displacement parameter of the imaging element by limiting the selection of the feature points to be from what belong to a certain plane. The structure of each device will be detailed below.

The stationary object map detecting device 3 is provided with a memory, an arithmetic element, and the like. The stationary object map detecting device 3 is adapted to detect a stationary object from images 2 taken at different points by the imaging area 320 of the imaging element. The “stationary object” herein is one example of the “plane-like stationary object” in the present invention and denotes an object or a body at rest. The stationary object is a comprehensive concept including not only a completely motionless object, but also an object which is displaced at a sufficiently lower speed than the moving speed of the imaging correcting apparatus 1, or an object generally considered to be at rest. The method of detecting the stationary object may be any of various methods, in addition to temperate matching, in which a taken image is compared with the template of an object generally considered to be at rest. The method is not particularly limited.

The stationary object plane detecting device 4 is provided with a memory, an arithmetic element, and the like. The stationary object plane detecting device 4 is adapted to detect the object 310 which is a portion that belongs to the same plane 300, from the detected maps. The “plane” herein has a substantially plane structure in the real space, such as an advertising sign and a street directory. The method of detecting the portion that belongs to the same plane 300 may be any of various methods, in addition to temperate matching, in which a taken image is compared with the template of an object generally considered to have the substantially plane structure, such as an advertising sign and a street directory. The method is not particularly limited.

The feature point detecting device 5 is provided with a memory, an arithmetic element, and the like. The feature point detecting device 5 is adapted to detect a set of the feature points having a predetermined feature (e.g. Q_{A0}, Q_{A1}, Q_{A2}, Q_{A3}, Q_{B0}, Q_{B1}, Q_{B2}, and Q_{B3} shown in FIG. 3) from the object 300 which is the portion that belongs to the plane 300. Each feature point is detected, for example, as having a brightness value greater than a predetermined brightness value, from edge intersections extracted from the images.

The feature recording device 6 is provided with a hard disk or the like. The feature recording device 6 is adapted to record and store the set of the feature points.

The feature point displacement amount detecting device 65 is provided with a memory, an arithmetic element, and the like. The feature point displacement amount detecting device 65 detects the amount of displacement: where the set of the feature points detected in the image A taken at the point a is displaced to in the image B taken at the point b.

The feature point change detecting device 7 is provided with a memory, an arithmetic element, and the like. The feature point change detecting device 7 is adapted to detect a change in the feature points between the images A and B. The feature point change detecting device 7 is provided with a feature point reference point determining device 71, a feature point relative vector calculating device 72, and a feature point relative vector change detecting device 73. The feature point reference point determining device 71 determines a feature point that is the basis of a relative vector. The feature point relative vector calculating device 72 calculates the relative vector, obtained by connecting the feature point determined as the basis and another feature point. Incidentally, relative vectors are linearly independent to each other. The feature point relative vector change detecting device 73 detects how the relative vector changes on the basis of how the set of the feature points is displaced between the images. In other words, the change in the feature points is detected as the relative vector.

The imaging element rotation amount detecting device 8 is provided with a memory, an arithmetic element, and the like. The imaging element rotation amount detecting device 8 is adapted to detect the amount of rotation of the imaging element, as one example of the displacement parameter of the imaging element having the image correcting device 1, from the change in the feature points, i.e. the change in the relative vector.

As explained above, according to the image correcting device 1 constructed as shown in FIG. 4, the set of the feature points having the predetermined feature is detected from the object 300 which is the portion that belongs to the plane 300, so that it is possible to obtain the amount of rotation of the imaging element with the relatively small calculation amount.

(1-3) Operation Principle

Next, the operation principle of the image correcting device 1 in the embodiment as constructed above will be explained with reference to FIG. 5 and FIG. 6, in addition to FIG. 1 to FIG. 4. FIG. 5 is a flowchart showing the operation process of the image correcting apparatus in the first embodiment of the present invention. FIG. 6 is a flowchart showing the detailed operation process of the image correcting apparatus in the first embodiment of the present invention.

In FIG. 5, firstly, the image correcting device 1 reads the image A taken at the point a, from among the images 2 (step S1). The stationary object map detecting device 3 and the stationary object plane detecting device 4 detect the map of the object 310 at rest which has the portion that belongs to the same plane 300 (step S2). The feature point detecting device 5 detects the set of the feature points which belongs to the object 310, and the detected set of the feature points is recorded in the feature point recording device 6 (step S3). The image correcting apparatus 1 then reads the image B (step S4). The feature point displacement amount detecting device 65 detects the amount of displacement of the feature points between the images A and B. With reference to the detection result, the feature point change detecting device 7 detects the amount of change: how the position of each feature point changes between the images A and B (step S5). Therefore, the imaging element rotation amount detecting device 8 can detect the amount of rotation of the imaging element, from the amount of change, using the condition of belonging to the same plane (step S6).

The aforementioned process will be detailed using equations, as occasion demands, in accordance with steps in FIG. 6.

In FIG. 6, firstly, each of the points that correspond to the object 310 which belongs to the plane 300 is searched for by the stationary object map detecting device 3 and the stationary object plane detecting device 4, from the images A and B (step S7).

Feature points {P₀, P₁, P₂, . . . , Pₙ} included in the object 310 are selected by the feature point detecting device 5 (step S8).

Here, as shown in FIG. 1, it is assumed that the two-dimensional coordinate system of the imaging area 320 is (u, v) and that the two-dimensional coordinate system of the plane 300 is (s, t). The feature point reference point determining device 71 determines P₀ as the basis in the coordinates (s, t), and the feature point relative vector calculating device 72 calculates the relative vector which connects P₀ and another feature point. The relative vector is expressed by an Equation 4, and the map of the relative vector in the imaging area 320 is expressed by an Equation 5 (step S9).

\vec{p}={\vec{p}₁, . . . \vec{p}ₙ} [Equation 4]

\vec{q}={\vec{q}₁, . . . \vec{q}ₙ} [Equation 5]

At this time, if yaw-pitch-roll transformation is performed by the rotation matrix R at the origin O, the coordinates (u, v) of the imaging area 320 are rotation-transformed to be coordinates (u′, v′). Here, the relation in each of the coordinates before and after the transformation is expressed by an Equation 6, using components R₁₁ to R₃₃ of the rotation matrix R and a focal distance f. Therefore, the map of the relative vector of the feature point in the coordinates (u′, v′) after the transformation is expressed by an Equation 7.

$$\begin{matrix}{u}^{′} = \frac{f ( {R}_{11} u + {R}_{12} v + {R}_{13} f )}{{R}_{31} u + {R}_{32} v + {R}_{33} f} \\ {v}^{′} = \frac{f ( {R}_{21} u + {R}_{22} v + {R}_{23} f )}{{R}_{31} u + {R}_{32} v + {R}_{33} f} & [ Equation 6 ] \\ \begin{matrix}{\vec{q}}_{m}^{′} = ( Δ {u}_{m}^{′} , Δ {v}_{m}^{′} ) \\ = ( {u}_{m}^{′} - {u}_{0}^{′} , {v}_{m}^{′} - {v}_{0}^{′} ) \\ = ( \begin{matrix}\frac{f ( {R}_{11} {u}_{m} + {R}_{12} {v}_{m} + {R}_{13} f )}{{R}_{31} {u}_{m} + {R}_{32} {v}_{m} + {R}_{33} f} - \\ \frac{f ( {R}_{11} {u}_{0} + {R}_{12} {v}_{0} + {R}_{13} f )}{{R}_{31} {u}_{0} + {R}_{32} {v}_{0} + {R}_{33} f} , \\ \frac{f ( {R}_{21} {u}_{m} + {R}_{22} {v}_{m} + {R}_{23} f )}{{R}_{31} {u}_{m} + {R}_{32} {v}_{m} + {R}_{33} f} - \\ \frac{f ( {R}_{21} {u}_{0} + {R}_{22} {v}_{0} + {R}_{23} f )}{{R}_{31} {u}_{0} + {R}_{32} {v}_{0} + {R}_{33} f}\end{matrix} )\end{matrix} & [ Equation 7 ]\end{matrix}$$

The imaging element rotation amount detecting device 8 determines the rotation matrix, which gives the rotation transformation, such that the corresponding relative vectors are similar between the images A and B, to thereby detect the amount of rotation of the imaging element (step S10). Specifically, using R_{A} and R_{B}, the imaging element rotation amount detecting device 8 performs the rotation transformation such that the imaging area 320 and the plane 300 are parallel to each other at the points a and b at which the images A and B are taken. At this time, as described above, since the imaging area 320 after the transformation at the point a is parallel to the imaging area 320 after the transformation at the point b, the objects 310 which belong to the plane 300 are similar to each other in the both imaging areas after the transformation. Therefore, an Equation 8 is to hold true, and the Equation 7 is substituted for the Equation 8 to obtain an Equation 9 (step S10).

\vec{q}′_{Am}=k′\vec{q}′_{Bm} [Equation 8]

Δu′_{Am}Δv′_{Bm}=Δu′_{Bm}Δv′_{Am} [Equation 9]

Here, the subscript “Am” denotes that it is about the m-th feature point which belongs to the image A. The same is true for “Bm”. For the other feature points, relational expressions corresponding to the Equation 9 are also obtained in the same manner. Thus, the rotation matrices R_{A} and R_{B} are obtained from the simultaneous equations of the relational expressions. The rotation matrix R is also obtained because the right side of the Equation 2 is equal to the right side of the Equation 3.

Incidentally, these can be also performed on many feature points included in the plane 300 for statistical processing. In that case, if the feature points are detected in the object 310 which belongs to the plane 300 as described above, the displacement of the feature points is easily predicted, and what makes an abnormal move can be removed in advance, so that it is possible to reduce an influence of errors.

Moreover, in order to make the two planes (the plane 300 and the imaging area 320) parallel, only yaw-pitch transformation (i.e. two-axis rotation) will do, so that the relation of an Equation 10 is established. Therefore, the desired rotation matrix can be obtained by solving an Equation 11 with respect to the relative vectors q_{Am} and q_{Bm}.

$${\vec{q}}_{B} = {k}^{″} ( \begin{matrix}cos ϕ & - sin ϕ \\ sin ϕ & cos ϕ\end{matrix} ) \cdot {\vec{q}}_{A} \qquad [ Equation 10 ]$$

∥\vec{q}_{Am}∥=k″∥\vec{q}_{Bm}∥ [Equation 11]

As described above, according to the embodiment, it is possible to preferably calculate the displacement parameter while reducing the necessary calculation amount, so that it is extremely useful in practice.

### (2) Second Embodiment

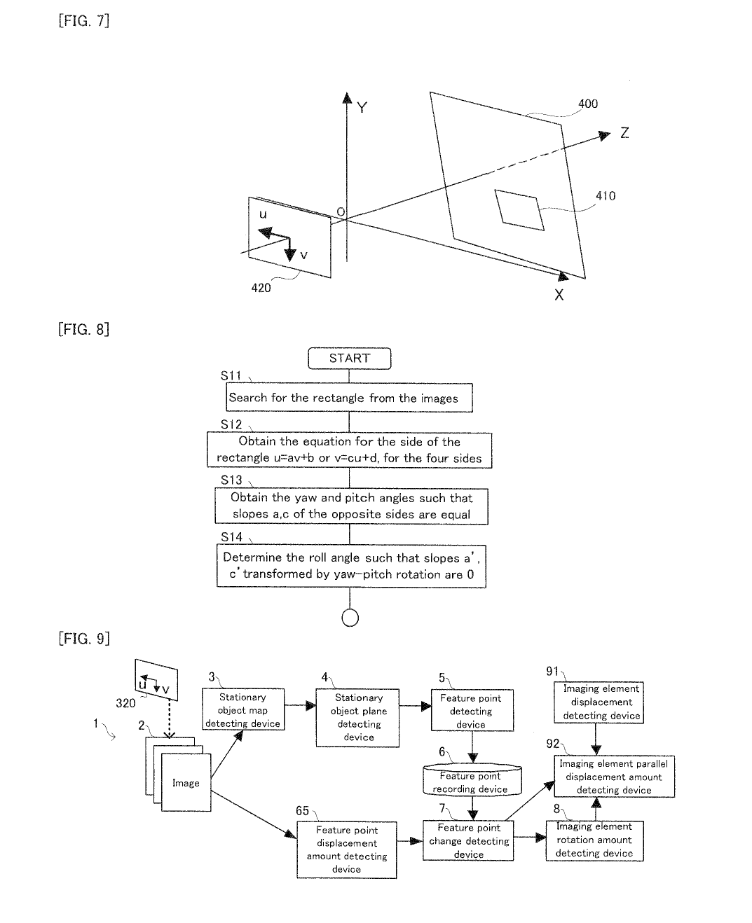

The structure and operation process of an image correcting apparatus in a second embodiment will be described with reference to FIG. 7 and FIG. 8.

FIG. 7 is a perspective view showing a coordinate system in the second embodiment. FIG. 8 is a flowchart showing the operation process of the image correcting apparatus in the second embodiment of the present invention.

The embodiment particularly characterizes in that an object which belongs to a plane 400 is a rectangle, as one example of the “set of the points which constitutes the known shape” in the present invention. Incidentally, the same constituents as those in the aforementioned embodiment carry the same reference numerical, and the explanation thereof will be omitted, as occasion demands.

In FIG. 7, it is considered that a rectangular object 410 which belongs to the plane 400 is imaged by a pinhole camera having an imaging area 420. It is assumed that the pinhole is an origin O, that the optical axis is a Z axis, and that the lateral and longitudinal directions of the imaging area 420 are an X axis and a Y axis, respectively. At this time, the map of the rectangle 410 is rectangular when the imaging area 420 is parallel to the plane 400, regardless of the imaging positions. A specific operation process for obtaining the rotation matrix EL using this characteristic will be shown in FIG. 8.

In FIG. 8, firstly, the stationary object map detecting device 3 and the stationary object plane detecting device 4 search for the rectangle from among the images taken in the imaging area 420 (step S11). As an equation which expresses the map in the imaging plane (u, v) with the four sides of the rectangle, Equations 12 to 15 are obtained (step S12).

u=a₁v+b₁ [Equation 12]

u=a₂v+b₂ [Equation 13]

v=c₃u+d₃ [Equation 14]

v=c₄u+d₄ [Equation 15]

Then, in order to make the plane 400 and the imaging area 420 parallel, yaw-pitch transformation shown in an Equation 16 is performed.

$$[ \begin{matrix}{X}^{′} \\ {Y}^{′} \\ {Z}^{′}\end{matrix} ] = [ \begin{matrix}1 & 0 & 0 \\ 0 & cos θ & - sin θ \\ 0 & sin θ & cos θ\end{matrix} ] [ \begin{matrix}cos φ & 0 & - sin φ \\ 0 & 1 & 0 \\ sin φ & 0 & cos φ\end{matrix} ] [ \begin{matrix}\begin{matrix}X \\ Y\end{matrix} \\ Z\end{matrix} ] \qquad [ Equation 16 ]$$

From the Equation 1 and the Equation 16, the relation between the map before the transformation (u, v) and the map after the transformation (u′, v′) is expressed by an Equation 17. The Equation 17 is substituted for the Equation 12, and the equation is rearranged with respect to u′, v′, to thereby provide an Equation 18. In other words, the straight line of the Equation 12 is transformed to the straight line of the Equation 18 by the yaw-pitch transformation. The same is true for the straight lines of the Equations 13 to 15.

$$\begin{matrix}u = \frac{f ( {u}^{′} cos φ - {v}^{′} sin θsin φ + f cos θ sin φ )}{- {u}^{′} sin φ - {v}^{′ } sin θ cos φ + f cos θcosφ} \\ v = \frac{f ( {v}^{′} cos θ + f sin θ )}{- {u}^{′} sin φ - {v}^{′} sin θ cos φ + f cos θcos φ} & [ Equation 17 ] \\ {u}^{′} = \frac{( f sin φ - {b}_{1} cos φ ) sin θ + {a}_{1} f cos θ}{f cos φ + {b}_{1} sin φ} {v}^{′} + \frac{{f}^{2} ( {a}_{1} sin θ - cos θ sin φ ) + {b}_{1} f cos θ cos φ}{f cos φ + {b}_{1} sin φ} & [ Equation 18 ]\end{matrix}$$

Therefore, the relation between the yaw angle φ and the pitch angle θ is obtained as in Equations 19 and 20 such that the slopes of two pairs of opposite sides of the four sides after the transformation are equal to each other (step S13). Then, from the condition that the right sides of the Equations 19 and 20 are equal, the yaw angle φ is obtained, and the pitch angle θ is further obtained.

$$\begin{matrix}tan θ = \frac{( {a}_{1} - {a}_{2} ) f cos φ + ( {a}_{1} {b}_{2} - {a}_{2} {b}_{1} ) sin φ}{{b}_{1} - {b}_{2}} & [ Equation 19 ] \\ tan θ = \frac{( {c}_{4} - {c}_{3} ) f cos φ + ( {d}_{3} - {d}_{4} ) sin φ}{{c}_{3} {d}_{4} - {c}_{4} {d}_{3}} & [ Equation 20 ]\end{matrix}$$

Moreover, the roll angle φ is obtained, relatively easily, by setting the slope of the straight line after the yaw-pitch transformation to be zero (step S14).

As described above, according to the embodiment, if the equations sufficient to determine the rotation angle are known with respect to the shape of the object, it is possible to more easily calculate the displacement parameter, such as the yaw angle θ.

### (3) Third Embodiment

The structure and operation process of an image correcting apparatus in a third embodiment will be described with reference to FIG. 9, in addition to FIG. 1 and FIG. 2. FIG. 9 is a block diagram conceptually showing the basic structure of the image correcting apparatus in the third embodiment of the present invention. Incidentally, the same constituents as those in the aforementioned embodiments carry the same reference numerical, and the explanation thereof will be omitted, as occasion demands.

In FIG. 9, in particular, the image correcting apparatus in the embodiment is provided with an imaging element displacement distance detecting device 91 and an imaging element parallel displacement amount detecting device 92 in addition to the constituents of FIG. 4. By this, the amount of parallel displacement of the imaging element is preferably obtained.

The imaging element displacement distance detecting device 91 is one example of the “measuring device” of the present invention. For example, the imaging element displacement distance detecting device 91 is provided with an integrating travel distance meter (a so-called odometer) or the like, and it detects a distance r between the points a and b.

The imaging element parallel displacement amount detecting device 92 is one example of the “second specifying device” of the present invention. The imaging element parallel displacement amount detecting device 92 is provided with a memory, an arithmetic element, and the like, and it calculates the three-dimensional amount of parallel displacement Δx, Δy, and Δz in the Equation 2. In addition, it is also possible to calculate the relative position from the camera of the object 310. At this time, if the plane 300 is parallel to the imaging area 320, all the feature points that belong to the plane 300 are equally distant on the optical axis from the imaging area 320. Thus, the displacement of the map in the amount of parallel displacement in the Z-axis direction coincides at all the feature points. This extremely facilitates the calculation of the amount of parallel displacement.

Hereinafter, a procedure for calculating the amount of parallel displacement will be detailed. If the yaw-pitch-roll transformation is performed by the aforementioned rotation matrices R_{A} and R_{B}, the respective axes in the coordinate systems of the imaging areas 320 at the points a and b are parallel to each other. Therefore, the coordinate systems after the transformation at the points a and b can be matched only by the parallel displacement shown in an Equation 21.

$$[ \begin{matrix}{X}^{′} \\ {Y}^{′} \\ {Z}^{′}\end{matrix} ] = [ \begin{matrix}X + Δ x \\ Y + Δ y \\ Z + Δ z\end{matrix} ] \qquad [ Equation 21 ]$$

Here, the map (u′, v′) in the imaging area 320 is expressed by Equations 22 and 23, obtained by substituting the Equation 21 for the Equation 1.

u′=fX′/Z′=(u+fΔx/Z)/1+Δz/Z) [Equation 22]

v=fY′/Z′=(v+fΔy/Z)/1+Δz/Z) [Equation 23]

Thus, if the maps of the feature points (u₁, v₁), (u₂, v₂), (u₁′, v₁′), and (u₂′, v₂′) are selected and if the distance between the plane 300 and the pinhole O at the point a is z (>=0), each equation in an Equation 24 is established, to thereby provide the amount of parallel displacement Δx, Δy, and Δz.

r²≈Δx²+Δy²+Δz²

f(u′₂−u′₁)Δx/z=(u′₁u₂−u₁u′₂)

f(v′₂−v′₁)Δy/z=(v′₁v₂−v₁v′₂)

(1+Δz/z)u′₁=u₁+fΔx/z [Equation 24]

As described above, according to the embodiment, since the feature points belong to the plan 300, the amount of parallel displacement of the imaging element is obtained, relatively easily, which is extremely useful in practice.

### (4) Fourth Embodiment

The structure and operation process of an image correcting apparatus in a fourth embodiment will be described with reference to FIG. 10. FIG. 10 is a block diagram conceptually showing the basic structure of the image correcting apparatus in the fourth embodiment of the present invention. Incidentally, the same constituents as those in the aforementioned embodiments carry the same reference numerical, and the explanation thereof will be omitted, as occasion demands.

In FIG. 10, in particular, the feature point detecting device 5 detects an arbitrary feature point, which is one example of the “arbitrary feature point” of the present invention. For example, the feature point detecting device 6 detects the feature point which belongs the plane 300 and the feature point which does not belong to the plane 300, from the images 2. A feature point distance detecting device 93 is one example of the “calculating device” of the present invention, and it detects the amount of displacement between the images of the arbitrary feature point. Therefore, if the parameter of the Equation 2 (i.e. the amount of parallel displacement and the amount of rotation) can be obtained by the aforementioned embodiments, the value is applied to the displacement between the images of the desired feature point, to thereby provide the distance between the feature point and the imaging element. Specifically, z is obtained by substituting the amount of parallel displacement and the amount of rotation of the three axes, which are obtained in the aforementioned embodiments, for the Equation 6, and x and y are also obtained from the Equation 1.

### (5) Fifth Embodiment

The structure and operation process of an image correcting apparatus in a fifth embodiment will be described with reference to FIG. 11. FIG. 11 is a block diagram conceptually showing the basic structure of the image correcting apparatus in the fifth embodiment of the present invention. Incidentally, the same constituents as those in the aforementioned embodiments carry the same reference numerical, and the explanation thereof will be omitted, as occasion demands.

In FIG. 11, in particular, the image correcting apparatus 1 is further provided with a stationary object recording device 31 and a stationary object map displacement detecting device 32, which are one example of the “reducing device” of the present invention. The stationary object recording device 31 records the stationary object detected by pattern matching. The stationary object map displacement detecting device 32 detects the displacement of the recorded stationary object map. As a result, it is possible to limit only the vicinity of the stationary object to be in an optical flow search range and to limit a window in which the feature point is displaced, so that there is a potential to reduce the calculation amount and the errors in the displacement of the feature points.

### (6) Sixth Embodiment

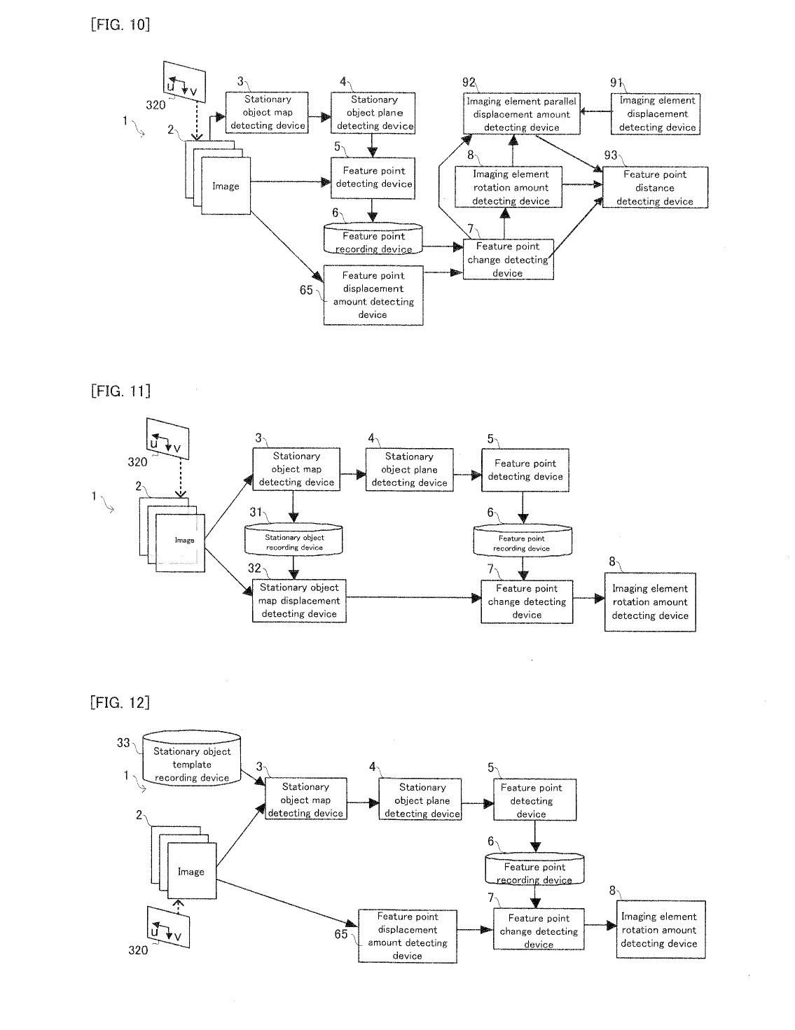

The structure and operation process of an image correcting apparatus in a sixth embodiment will be described with reference to FIG. 12. FIG. 12 is a block diagram conceptually showing the basic structure of the image correcting apparatus in the sixth embodiment of the present invention. Incidentally, the same constituents as those in the aforementioned embodiments carry the same reference numerical, and the explanation thereof will be omitted, as occasion demands.

In FIG. 12, in particular, a stationary object template recording device 33 is one example of the “recording device” of the present invention, and templates are prerecorded as candidates of the stationary object. For example, the templates of an advertising sign and a street directory are recorded. In light with the templates, the stationary object map detecting device 3 detects the map of the stationary object from the images 2, so that the accuracy of detecting the stationary object is improved.

### (7) Seventh Embodiment

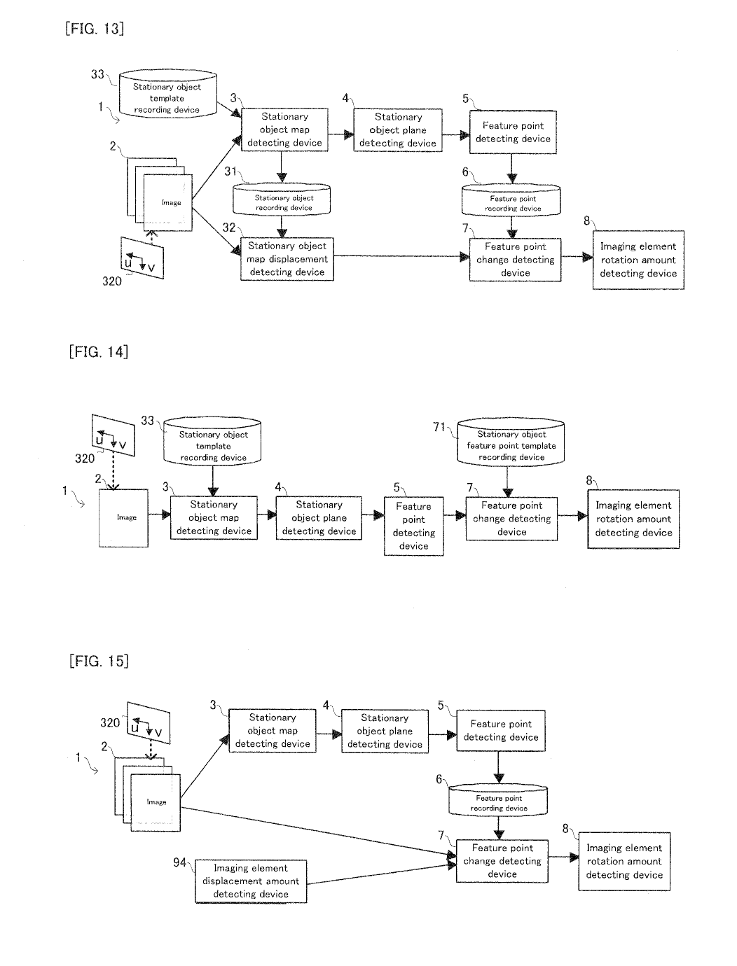

The structure and operation process of an image correcting apparatus in a seventh embodiment will be described with reference to FIG. 13. FIG. 13 is a block diagram conceptually showing the basic structure of the image correcting apparatus in the seventh embodiment of the present invention. Incidentally, the same constituents as those in the aforementioned embodiments carry the same reference numerical, and the explanation thereof will be omitted, as occasion demands.

In FIG. 13, in particular, the map of the stationary object 310 is detected from the images 2 in light with the templates recorded by the stationary object template recording device 33, and the detected map of the stationary object 310 is recorded by the stationary object recording device 31. Then, how to displace the recorded map of the stationary object 310 is detected by the stationary object map displacement detecting device 32. As described above, it is possible to limit the window in which the feature point is displaced, by using the accurately detected map of the stationary object, so that there is a potential to reduce the calculation amount and the errors in the displacement of the feature point.

### (8) Eighth Embodiment

The structure and operation process of an image correcting apparatus in an eighth embodiment will be described with reference to FIG. 14. FIG. 14 is a block diagram conceptually showing the basic structure of the image correcting apparatus in the eighth embodiment of the present invention. Incidentally, the same constituents as those in the aforementioned embodiments carry the same reference numerical, and the explanation thereof will be omitted, as occasion demands.

In FIG. 14, in particular, the feature point reference point determining device 71 is one example of the “recording device” of the present invention, and it records the templates of the feature points included in the stationary object. Therefore, the accurate feature points are selected in advance, which improves the accuracy of detecting the feature points and which also improves the accuracy of calculating the amount of rotation.

### (9) Ninth Embodiment

The structure and operation process of an image correcting apparatus in a ninth embodiment will be described with reference to FIG. 15. FIG. 15 is a block diagram conceptually showing the basic structure of the image correcting apparatus in the ninth embodiment of the present invention. Incidentally, the same constituents as those in the aforementioned embodiments carry the same reference numerical, and the explanation thereof will be omitted, as occasion demands.

In FIG. 15, in particular, an imaging element displacement amount detecting device 94 is one example of the “reducing device” of the present invention, and it detects the amount of displacement of the imaging element with hardware such as a sensor. As a result, it is possible to limit a detection window for the change in the feature points, so that it is possible to reduce the calculation amount.

As explained above, according to the image correcting apparatus 1 in each of the embodiments, it is possible to preferably reduce the calculation amount required to obtain the displacement parameter which indicates how the imaging element is displaced between the imaging points. The obtained displacement parameter can be used for the correction or the like of the taken images, so that it is extremely useful in practice.

Moreover, the operation process shown in the aforementioned embodiments may be realized by the image correcting apparatus built in the image correcting apparatus or connected to the exterior. Alternatively, it may be realized by operating the image correcting apparatus on the basis of an image correcting method provided with a feature point detecting process, a change detecting process, and a first specifying process. Alternatively, it may be realized by making a computer read a computer program, wherein the computer is provided with the image correcting apparatus provided with a feature point detecting device, a change detecting device, and a first specifying device.

Incidentally, the present invention is not limited to the aforementioned embodiments, but various changes may be made, if desired, without departing from the essence or spirit of the invention which can be read from the claims and the entire specification. An image correcting apparatus and method, and a computer program, all of which involve such changes, are also intended to be within the technical scope of the present invention.

### INDUSTRIAL APPLICABILITY

The mage correcting apparatus and method, and the computer program of the present invention can be applied to an object detecting apparatus, mounted on a vehicle, for detecting an obstacle in the surroundings or a recognizing apparatus for recognizing the three-dimensional position of an object when an object is picked up by a robot hand or the like. They can be also applied to an imaging apparatus such as a digital camera which can correct hand movement. They can be also applied to an image correcting apparatus or the like which is mounted on various computer equipment for consumer use or for commercial use, or which can be connected to various computer equipment.

1-10. (canceled)

11. An image correcting apparatus comprising:
a feature point detecting device for detecting a set of feature points from a plurality of images taken at a plurality of points by an imaging element;
a change detecting device for detecting a change in relative positions between the images, with respect to the detected set of feature points; and
a first specifying device for specifying amount of rotation between the points of the imaging element, on the basis of the detected change,
said feature point detecting device detecting a set of points which belongs to a plane-like stationary object, as the set of the feature points,
said first specifying device specifying the amount of rotation, as amount of rotation that the relative positions of the feature points are similar to each other between the images.

12. The image correcting apparatus according to claim 11, wherein said first specifying device specifies the amount of rotation, as amount of rotation that graphic shapes formed by the set of the feature points are similar to each other between the images.

13. The image correcting apparatus according to claim 11, wherein said first specifying device
determines one feature point of the detected set of the feature points as a reference point,
calculates a relative vector directed from the determined reference point to each of other feature points, and
specifies the amount of rotation such that the calculated relative vectors are similar between the images.

14. The image correcting apparatus according to claim 11, wherein said feature point detecting device detects a set of points which constitutes a known shape, as the set of the feature points.

15. The image correcting apparatus according to claim 11, further comprising:
a measuring device for measuring a distance between the points of the imaging element; and
a second specifying device for specifying amount of parallel displacement between the points of the imaging element, on the basis of the specified amount of rotation and the measured distance between the points of the imaging element.

16. The image correcting apparatus according to claim 11, wherein
said change detecting device detects the change about an arbitrary feature point, in addition to the set of the feature points, and
said image correcting apparatus further comprises a calculating device for calculating a distance to the arbitrary feature point, at least on the basis of the detected change about the arbitrary feature point.

17. The image correcting apparatus according to claim 11, further comprising: a reducing device for reducing an area of the images which is a target to detect the change, on the basis of at least one of the change about the plane-like stationary object and the distance between the points of the imaging element.

18. The image correcting apparatus according to claim 11, further comprising: a recording device for recording at least one candidate of the feature points and the plane-like stationary object,
said feature point detecting device detecting the feature points with reference to the recorded candidate.

19. An image correcting method comprising:
a feature point detecting process of detecting a set of feature points from a plurality of images taken at a plurality of points by an imaging element;
a change detecting process of detecting a change in relative positions between the images, with respect to the detected set of feature points; and
a first specifying process of specifying amount of rotation between the points of the imaging element, on the basis of the detected change,
said feature point detecting process detecting a set of points which belongs to a plane-like stationary object, as the set of the feature points,
said first specifying process specifying the amount of rotation, as amount of rotation that the relative positions of the feature points are similar to each other between the images.

20. A computer-readable medium containing a computer program for making a computer function as an image correcting apparatus,
said image correcting apparatus comprising:
a feature point detecting device for detecting a set of feature points from a plurality of images taken at a plurality of points by an imaging element;
a change detecting device for detecting a change in relative positions between the images, with respect to the detected set of feature points; and
a first specifying device for specifying amount of rotation between the points of the imaging element, on the basis of the detected change,
said feature point detecting device detecting a set of points which belongs to a plane-like stationary object, as the set of the feature points,
said first specifying device specifying the amount of rotation, as amount of rotation that the relative positions of the feature points are similar to each other between the images.

21. The image correcting apparatus according to claim 12, wherein said feature point detecting device detects a set of points which constitutes a known shape, as the set of the feature points.

22. The image correcting apparatus according to claim 13, wherein said feature point detecting device detects a set of points which constitutes a known shape, as the set of the feature points.

23. The image correcting apparatus according to claim 12, further comprising: a reducing device for reducing an area of the images which is a target to detect the change, on the basis of at least one of the change about the plane-like stationary object and the distance between the points of the imaging element.

24. The image correcting apparatus according to claim 13, further comprising: a reducing device for reducing an area of the images which is a target to detect the change, on the basis of at least one of the change about the plane-like stationary object and the distance between the points of the imaging element.

25. The image correcting apparatus according to claim 14, further comprising: a reducing device for reducing an area of the images which is a target to detect the change, on the basis of at least one of the change about the plane-like stationary object and the distance between the points of the imaging element.

26. The image correcting apparatus according to claim 15, further comprising: a reducing device for reducing an area of the images which is a target to detect the change, on the basis of at least one of the change about the plane-like stationary object and the distance between the points of the imaging element.

27. The image correcting apparatus according to claim 16, further comprising: a reducing device for reducing an area of the images which is a target to detect the change on the basis of at least one of the change about the plane-like stationary object and the distance between the points of the imaging element.

28. The image correcting apparatus according to claim 12, further comprising: a recording device for recording at least one candidate of the feature points and the plane-like stationary object,
said feature point detecting device detecting the feature points with reference to the recorded candidate.

29. The image correcting apparatus according to claim 13, further comprising: a recording device for recording at least one candidate of the feature points and the plane-like stationary object,
said feature point detecting device detecting the feature points with reference to the recorded candidate.

30. The image correcting apparatus according to claim 14, further comprising: a recording device for recording at least one candidate of the feature points and the plane-like stationary object,
said feature point detecting device detecting the feature points with reference to the recorded candidate.
